(19) United States
(12) Patent Application Publication
(10) Pub. No.: US 2018/0161705 A1
(43) Pub. Date: Jun. 14, 2018

(54) STACKED-PLATE FILTER AND A METHOD OF USE

(71) Applicant: SPECIALIZED DESANDERS INC., Calgary (CA)

(72) Inventor: Christopher A. HEMSTOCK, Calgary (CA)

(21) Appl. No.: 15/835,039

(22) Filed: Dec. 7, 2017

Related U.S. Application Data
(60) Provisional application No. 62/433,495, filed on Dec. 13, 2016.

(51) Int. Cl. B01D 29/46; B01D 29/13; B01D 29/92

(52) U.S. Cl. CPC B01D 29/46; B01D 29/13; B01D 2313/08; B01D 2313/20; B01D 29/925

(57) ABSTRACT

A stacked-plate filter removes particulates from a fluid stream. Each plate is a surface of revolution, including an annular plate having a central opening and an outer periphery. A plurality of plates are stacked axially and spaced to form gaps as fluid pathways between the central opening and periphery. Depending on the direction fluid flow, inner or outer edges at the central opening or periphery respectively form inlet edges; the inlet edges of adjacent plates being misaligned to form an offset gap interface for minimizing particulate clogging thereat. The inlet edge can be pleated, forming radially-extending edges for angular misalignment. Identical and adjacent plates can be alternated face-up and face down to form the offset gap interface. The filter can be fit within a housing and forming an annulus therebetween, the central opening and annulus forming one or the other of the fluid inlet and outlet.

### FIELD OF THE DISCLOSURE

The present disclosure relates generally to a filtering device and in particular to a high-pressure disc or stacked-plate type filtering device and method for removing particulates from an input fluid stream.

### BACKGROUND

Production from wells in the oil and gas industry often contains particulates such as sand. These particulates could be part of the formation from which the hydrocarbon is being produced, introduced from hydraulic fracturing, or fluid loss material from drilling mud or fracturing fluids, or from a hydrocarbon phase change of produced hydrocarbons caused by changing conditions at the wellbore. As the particulates are produced, erosion and plugging of production equipment can occur. In a typical start-up after stimulating a well by fracturing, the stimulated well may produce sand until the well has stabilized, often lasting for several months after production commences. Other wells may produce sand for a much longer period of time.

Erosion of the production equipment can be severe enough to cause catastrophic failure. High fluid stream velocities are typical and are even purposefully designed to encourage the elutriation of particulates up the well to surface. An erosive failure is a serious safety and environmental issue for the well operator. A failure, such as a breach of high pressure piping or equipment, releases uncontrolled high velocity flow of fluid, the energy of which, and properties of which are hazardous to service personnel and the environment. Cleanup and repair are expensive in both the remediation and loss of production.

Particulates contaminate surface equipment and produced fluids. Contamination impairs the normal operation of the oil and gas gathering systems and process facilities. Therefore, desanding devices are required for removing sand from the fluid stream. Due to the nature of the gases handled, including pressure and toxicity, all vessels and pressure piping in desanding devices must be manufactured and approved by appropriate boiler and pressure vessel safety authorities.

Some prior-art desanding devices use filters and/or screens for removing particulates from an input fluid stream. However, these prior-art desanding devices have drawbacks such as low or even marginal tolerance for pressure drop, usually collapse at low pressure, individual ratings vary between manufacturer, but in general fail at pressures considerably lower than the maximum allowable working pressure of the vessel that contains the filter. Another drawback of such prior-art devices is that the screens thereof are easy to be plugged or clogged due to the accumulation of particulates thereon.

Stacked plate or multiple-disc type filters are known, such as in U.S. Pat. No. 4,753,731 to Drori, and US application US2015/0144546, published May 28, 2015, each of which disclose a plurality of paired, cooperating disc-like filter surfaces. Such designs are designed to form annular pockets between adjacent discs for receiving and holding foreign particulates separated from the fluid. As stated by Drori, multiple-disc filters have a number of important advantages over other types of filters, such as the apertured screen type. One noted advantage is the higher quantities of foreign particulates which the multiple-disc type filter is capable of removing and retaining as compared to the apertured-screen filter. Another noted advantage is the higher resistance to rupture that the multiple-disc filter has compared to the ubiquitous apertured-screen filter.

However such devices, applied in the irrigation industry, have not made their way into the commercial context of the hydrocarbon-processing fields. Several challenges to filtering in such fields includes capital cost, ongoing maintenance cost, high pressured resistance and operating duration before a clogging and need for cleaning, and high pressure drop across the device.

It is therefore an object to provide an economic particulate-filtering device and method of operation.

### SUMMARY

According to one aspect of this disclosure, there a high pressure filter, such as that for removing sand from a fluid stream such as that from oil and gas produced fluids. The filter comprises a plurality of stacked discs or plates which are housed in a vessel such as a pressure vessel. The plates are basically formed as a surface of revolution, having parallel surfaces, and in one embodiment form annular plates having parallel upper and lower planar surfaces. The plates are stacked, generally along their axis of rotation, in parallel yet spaced, arrangement. Each pair of adjacent plates forms a generally uniform gap therebetween. In embodiments, the inlet periphery of the stacked plates is pleated to provide a large cross-sectional inlet area and, further, the periphery of adjacent plates can be offset to prevent clogging. In other embodiments, the stack of plates is resistant to collapse under high pressure differentials and if the pressure drop does increase over time, the stack can be backflushed or manipulated to clear particulates.

In more detail, each of the plates has an internal port about the plate axis, the internal port having an inner edge. Each plate has an outer periphery having an outer edge.

The internal port is fluidly connected to one of the fluid inlet or fluid outlet. For maximizing inlet cross-sectional area of the fluid inlet, the internal port typically forms the fluid outlet, with the fluid inlet formed at the outer periphery. The stack is supported in a housing or vessel forming an annulus therebetween. For the purpose of filtering particulates from the fluid stream, the stack can be oriented in any direction. The annulus is fluidly connected to the other of the fluid outlet or fluid inlet.

For the particular filter application the outer edges, or inner edges, whichever is fluidly connected to the fluid inlet, is deemed herein to be the gap interface, or corresponding axial offset between adjacent edges, through which the fluid stream enters. Fluid flows radially into the gap interface from out-to-in or in-to-out. When the feedstream is flowing in-to-out, the gap interface at the respective pair of adjacent inner edges exclude particulates from flowing from the axis, between the plates and through the gap, to the outer periphery. When flowing out-to-in, gap interface at the respective pair of adjacent outer edges exclude particulates from flowing from outside the stack, between the plates and through the gap, to the axis and the internal port. The size of the gap interface between each pair of adjacent plates and, at the fluid inlet, is sized to exclude particulates from entering therein.

In the prior art, each plate of an axially stack of plates has been of like design, resulting in coincident inner and outer edges, aligning along a perpendicular to the plane of the plates. In other words, when the plates happen to be stacked axially and secured together for use, all the inner and outer edges align axially.

Applicant has noted that individual particulates are often received, and become lodged along the prior art aligned and spaced edges of the gap interface. Applicant notes this related to aligned edges of the plates imposing retaining forces on the particulates received thereat. The retaining forces are not unlike wedge-type stops (like a door wedge) that functions largely because of the friction generated between the bottom of the door and the wedge, and the wedge and the floor (or other surface). Herein, an analog to the door stop's floor and door surfaces is provided by the adjacent plate's opposing edges, the particulate acting as a wedge in the gap between the two opposing edges.

In embodiments, two or more plates are provided, each plate having a shape that, when mounted for use, the gap interface of the adjacent plates is misaligned. Applicant discloses a filter with misalignment of the respective and adjacent edges straddling the gap at the fluid inlet so as to create an offset at the gap interface and thereby mitigate particulate retention and clogging. A slight misalignment of the edges at the gap interface creates a suitable offset that disables opposing frictional jamming forces that retain particulates. The amount of misalignment can be about the radius or ½ diameter of an average of the particulates distribution. There is no significant operable limitation on larger misalignments other that the imposition of larger needed dimensions on the vessel housing the stack, and strength and dimensional considerations on overhanging misaligned portions of the plate edges.

In another aspect, Applicant further discloses various techniques to enable misalignment whilst also minimizing the expense associated with the manufacture of a plurality of custom plate configurations. In some embodiments, each plate is laterally or rotationally displaced from the adjacent plate to cause misalignment of adjacent plates at each gap interface. This can be accomplished with variable or alternate mounting interfaces that enable choice between two or more lateral or radial positions respectively and thereby misaligning adjacent edges. In the case of lateral misalignment, such misalignment can be alternated to avoid axial drift of the stack and thus maintain the generally axial alignment of the stack of plates.

In another embodiment, plates can be reversible, an advantage being that a universal mounting interface can form two alignments with a single plate design.

In an embodiment, at least one plate is provided having an asymmetrical mounting capability for providing misalignment at the gap interface, either having two or more alternate mounting interfaces, which when selected during stacking, shift one plate from the other plate. Alternatively, a single plate design can have one mounting interface that is reversible and indexed relative to the plate position. Plates have first and second faces. to offset the gap interface, so that when flipped 180° about the axis, one face of the plate is turned over and mounted with a like plate's second face, mounted face-to-face and adjacent the first face, of an adjacent like plate.

While the misalignment is provided at the gap interface, for filtering the inlet fluid stream, there could also be a misalignment may also result at the edge adjacent the fluid outlet as a result of component and assembly design. In such cases, the advantages of the embodiments of the stacked-plate filter design could be realized even with a reverse flow, still obtaining the benefit of the misalignment principles set forth herein, yet in both flow directions.

In another embodiment, at least some plates, and particularly adjacent plates of the plurality of plates, have pleated edges. Pleated edges include scalloped, gear tooth-like and other like radial profiles along the plate's periphery. The pleated edges have several characteristics. The pleated edges form an elongated length of periphery within a given plate's effective, or enclosing diameter, undulating or variable radially along the circumference or periphery for increasing the surface area of each gap interface and providing a plurality of generally radially-extending edges. Further, while the plates can be of like dimensions, by providing alignment markers that are angularly offset, such as from a reference line or reference ray, yet aligned perpendicularly through the plate itself, plates can be misaligned simply by assembling adjacent plates one upright and the next plate upside down. Accordingly, two adjacent plates having the same inner and outer edge dimensions will be misaligned angularly, with one axial pleat or tooth offset angularly to misalign the radial profile of the gap interface. Each plate is angularly offset from the adjacent plate by a small angle, reducing the embedment of particulates into the gap interface between plates. Adjacent first faces of a pair of plates face each other and a pair of adjacent second faces face each other in the subsequent pair. Having an axial supporting structure will result in alternating angular misalignment. In another embodiment, the alignment markers can be such that the pleated plates can be misaligned both laterally and angularly.

In embodiments, the dimension of the gap is fixed and keeps the stack in compression to maintain the spacing between each plate to the specifications. In other embodiment, the plates can be manipulated to temporarily increase the gap spacing for back flushing. In an embodiment, wedge-shaped split rings may be used as spacers between plates, half of each ring being attached to a plate and the other half being attached to an assembly rod structure extending through the plates. Rotation of the assembly rod drives facing wedges against each other for ramping apart and increasing the gap between plates.

In another embodiment, the plates can be made of a synthetic material for reduced fluid friction, erosion resistance and structural capability. One such synthetic is a polymer material including silica. In one embodiment, the plates are made of a polymer material containing silica including nylon material. An injection mold process can be employed to inject the polymer material into a suitable mold for making the plates.

In one aspect, a stacked-plate filter is provided comprising a plurality of plates stacked along an axis and adjacent one another, each plate comprising a central opening forming an inner edge about the axis and an outer periphery forming an outer edge. Each pair of adjacent plates are parallel to one another and spaced apart to form a gap therebetween for flow of fluid therethrough from adjacent inlet edges formed at one of either the adjacent inner or outer edges. The inlet edge of one plate is misaligned from the respective adjacent inlet edge of the adjacent plate, for forming an offset gap interface therebetween. In embodiments, the inlet edge of each plate is a pleated edge, the pleated edge of each pair of adjacent plates forming the fluid inlet. The inlet edge can be the outer edge. This outer edge of each plate can be a pleated edge forming a plurality of radially-extending edges. To misalign the inlet edges, the pleated edges of adjacent plates are angularly misaligned to form the offset gap interface at at least the radially-extending edges.

In another aspect, a filter assembly is provided comprising a vessel, a fluid inlet for injecting the fluid stream into the vessel; a fluid outlet for discharging cleaned fluid from the vessel; and the a stacked-plate filter described above. In an embodiment, the stacked-plate filter is housed within the vessel forming an annulus therebetween, the filter comprising a plurality of plates, each plate having an opening therethrough for forming an inner edge and an outer periphery forming an outer edge, the opening forming a fluid bore. One of the fluid bore or annulus is connected to the fluid inlet and the other of the annulus or fluid bore connected to the fluid outlet. Each pair of adjacent plates is parallel to one another and spaced apart to form a gap therebetween for fluid flow from the fluid inlet and between inlet edges at one of either the adjacent inner or outer edges to discharge from the other of the outer or inner edges to the fluid outlet, the inlet edge of one plate being misaligned from the respective adjacent inlet edge of the adjacent plate, for forming an offset gap interface therebetween.

Overall, a stacked-plate filter is provided embodying one or more of the features of a misaligned gap interface, pleated inlet edges, and plates that can be indexed for ease of misalignment of adjacent plates. Other embodiments include use of key and keyway alignment if adjacent pleats, with alignment markers for enabling misalignment of the adjacent plates when one plate is flipped face-to-face with the other plate. Use of polymer plates, and in particular a polymer with added silica provided superior plate performance.

### BRIEF DESCRIPTION OF THE DRAWINGS

FIG. 1A is a schematic cross-sectional view side of one embodiment of a filtering device in an enclosing vessel;

FIG. 1B is partial cross-sectional view of a supporting structure, or pipe, of the filter portion of FIG. 1A, filter plates installed thereon and gaps communicating with perforations pipe;

FIG. 1C is a plan view of one plate and cross-sectional view of the perforated pipe of FIG. 1B, taken along section lines B-B;

FIG. 2A is a plan view of a one face of a pleated filter plate suitable for the filtering device of FIG. 1A;

FIG. 2B is a cross-sectional side view of the filter plate of FIG. 2A along a one third section through the spacing boss;

FIG. 3 is a plan view of at least two adjacent stacked plates according to FIGS. 2A and 2B and illustrating an angular offset, such as for the filtering device and vessel of FIG. 1A;

FIGS. 4A and 4B are top-down and bottom up perspective views of alternating face-up, face-down stacked filter plates of the form according to FIG. 3, the plates separated for clarity of the bosses, teeth and face designations.

FIG. 5A is a cross-sectional view of six stacked filter plates according to FIG. 4 the section along a generally radial section line taken through the plate-spacing bosses;

FIG. 5B is a partial perspective view of adjacent tooth profiles of the pleated outer edge of adjacent plates, the plates having been angularly misaligned;

FIGS. 6A and 6B are schematics of the principles for flipping the same form of plates to obtain angular misalignment, FIG. 6A illustrating no misalignment when the plates are stacked without reversal, and FIG. 6B illustrating misalignment when the plates are stacked when reversed, the alignment holes now on opposing sides of the respective and angularly-rotated reference lines;

FIG. 7 is a plan view of a filter plate according to an alternative embodiment for lateral misalignment or offset;

FIG. 8A is a plan view of at least two adjacent stacked plates, of a plurality of stacked filter plates, accordingly to FIG. 7 illustrating lateral misalignment or offset of the gap interface;

FIG. 8B is a side view of eight adjacent stacked plates according to FIG. 8A illustrating lateral misalignment or offset of the gap interface through alternating offset of the plate's axes;

FIGS. 8C and 8D are schematics of the principles for flipping the same form of plates to obtain lateral misalignment, FIG. 8C illustrating no misalignment when the plates are stacked without reversal, and FIG. 8D illustrating misalignment when the plates are stacked when reversed, the alignment holes now laterally shifted relative to the axis;

FIG. 9 is a plan view of a filter plate according to an alternative embodiment for lateral misalignment or offset and applicable to the reversal schematic of FIGS. 8C and 8D;

FIG. 10A is a plan view of a plurality of stacked filter plates of FIG. 9;

FIG. 10B is a side view of eight adjacent stacked plates according to FIG. 10A illustrating lateral misalignment or offset of the gap interface while maintaining alignment of the plate's axes;

FIG. 11A is a plan view of a wedge-shaped split ring interface for variable spacing of adjacent stacked filter plates, according to yet another embodiment;

FIG. 11B is a partial side view of wedge-shaped split ring of FIG. 11A in the plate at assembly holes, the left illustration being at a normal closed state for normal gap and filtering operation, and the right illustration being in an open state, such as for cleaning;

FIG. 12 is a top or front view of a filter plate having another form of periphery, according to an alternative embodiment; and

FIG. 13 is a side view of a stack of filter plates, according to an alternative embodiment, the stack formed of alternating large and small diameter plates for forming misalignment of the gap interface at the outer periphery.

### DETAILED DESCRIPTION

Herein, embodiments of a particulate or sand filtering device are disclosed. In an oil and gas field context, the filtering device receives a multiple phase, high pressure, input fluid feedstream F_{IN} that contains at least gas and entrained particulates. Hydrocarbons can be, and are usually, present. In some embodiments, the input fluid stream may also comprise liquids such as water and oil. A filter within the filtering device removes particulates from the feedstream and discharges a clean discharged fluid F_{OUT} free from oversized particulates, to downstream equipment. Herein, particulates are used generically for both individual particles and for an agglomeration, collection or other competent groupings of particles or particulates.

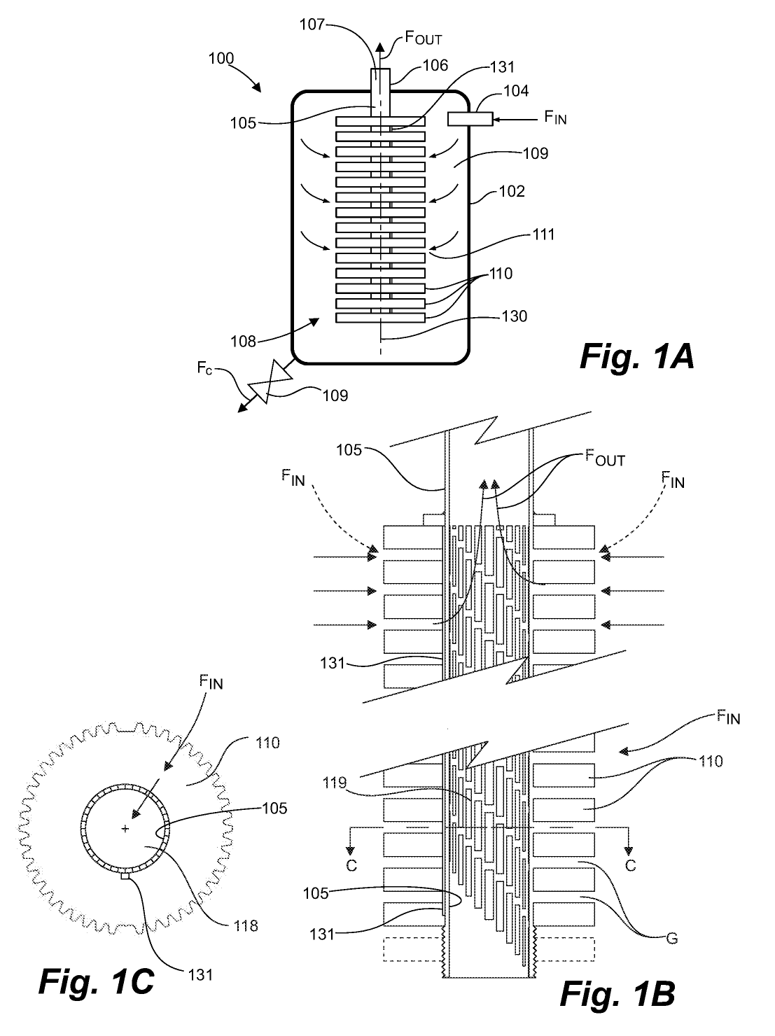

With reference to FIG. 1A, a filtering assembly 100 comprises a fluid housing or vessel 102, a fluid inlet 104 for injecting a fluid feedstream F_{IN}, including sand, into the vessel 102, and a fluid outlet 106 for discharging a clean fluid F_{OUT} A stacked-plate filter 108, according to one embodiment is fit within the vessel 102. A cleanout 109 can be provided at a bottom of the vessel 102 for removal of filtered particulates F_{C}.

The filter 108 comprises a plurality of stacked plates 110. Planar plates 110 are illustrated herein, having a form similar to a washer.

Each plate 110 is basically formed as a surface of revolution such as that formed as a planar shape, or other functionally similar shape such as right, conical plates arranged in a stacking arrangement similar to that used in a conical plate centrifuge. The plates are aligned along their central axis of revolution 130 and stacked axially one adjacent the other. The plates having parallel upper and lower planar surfaces. The surfaces of the adjacent plates are arranged in parallel, yet spaced, arrangement. Each plate 110 of a pair of adjacent plates 110P is spaced from the adjacent plate to form a generally uniform gap G therebetween. Fluid flows through the gap G from the fluid inlet and between adjacent inlet edges formed at one of either the adjacent inner or outer edges according to the configuration of the vessel 102.

Each annular plate 110 has an internal opening 118, typically centrally located about the central axis, the opening 118 having an inner periphery forming an inner edge 124 and the plate has an outer periphery forming an outer edge 122. Typically the central opening 118 is fluidly connected to one of the fluid inlet 104 or fluid outlet 106. In this embodiment, the annulus 109 is fluidly connected to the fluid inlet 104.

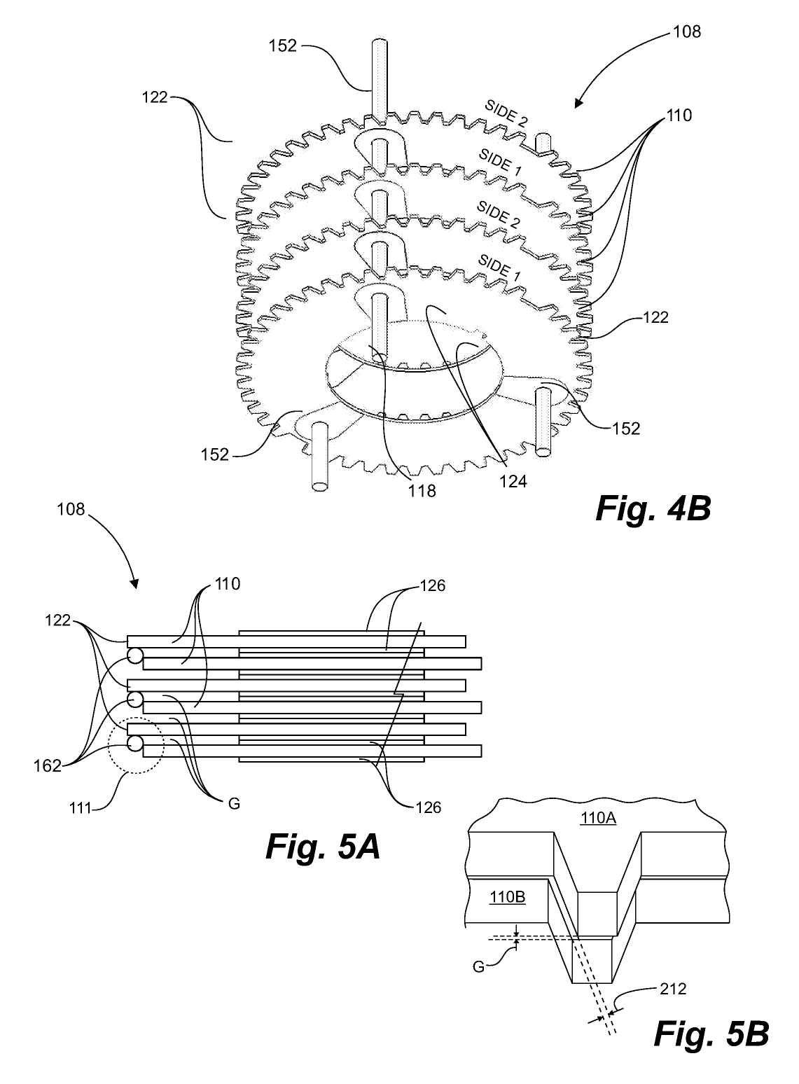

As shown in FIGS. 4A and 4B, the assembled stacked-plate filter 108 is shown with plates 110 spaced apart significantly apart in a non-operational arrangement for better viewing their relationship. In practice, one embodiment of each plate includes a 6″ (152 mm) outer diameter, having a 1/16″ (1.5 mm) thickness, a central opening having a 3″ (76 mm) inside diameter and having an actual gap G in the order of about 40/10,000″ (100 microns).

Stacked as filter 108, the plates' central ports 118,118 . . . form a fluid bore 107. The filter 108 utilizes the fluid bore 107, and a fluid annulus 109 between the filter 108 and the vessel 102 for treatment of the particulate-laden feedstream F_{IN}.

Three assembly rods 152 pass through respective alignment holes 128, the rods being used to align each plate with the adjacent plate, and can be used to fasten the plurality of plates in the stack. The perforated internal pipe 105 extends along the central opening 124 of the stacked plates 110 and is coupled to the fluid outlet 106. The pipe 105 can be used to fasten the plates together rather than, or in addition to the rods. The plates are compressed in the stack to maintain dimensional tolerance of the filtering gap G.

The filter 108 filters fluid passing therethrough between the annulus 109 and the fluid bore 107, or vice versa. In embodiment of FIG. 1A, the fluid inlet 104 is shown as communicating with the annulus 109 and fluid outlet 106 fluidly communicating with the fluid bore 107 respectively, although in other contexts, the reverse may be implemented.

For convenience and ease of describing relative orientation herein, the plates 110 are stacked axially along their axes of rotation 130, and for piping convenience the entire filter is often arranged vertically. Hence, the stack may be referred to upright or upside down with associated orienting terms as the context suggests, although the stacked filter 108 can itself be oriented and operated in any orientation.

Fluid flows radially through the gaps G,G . . . of the filter 108 from in-to-out or out-to-in. The opening of the gap G at the inner edges 124,124, or outer edges 122,122, of adjacent plates 110,110, and which are fluidly connected to the fluid inlet 104, are also termed generically as the adjacent inlet edges, and form a gap interface 111 therebetween.

When the feedstream is flowing in-to-out, the respective pair of adjacent inner edges 124,124 form the inlet edges to exclude particulates from flowing therebetween, and through the gap G between the plates 110,110. When flowing out-to-in, the respective pair of adjacent outer edges 122,122 form the inlet edges and exclude particulates from flowing from the outer edge 122, and through the gap G between the plates 110,110. For the annular, planar form of plates, the outer edges 122,122 have significantly more surface area and the flow gap interface 111 has significantly more cross-sectional flow area. Thus, an out-to-in flow arrangement can have advantages including longer operation before the pressure drop exceeds operational parameters or that the fluid inlet 104 becomes physically compromised by sand accumulation.

The size of the gap G, and accordingly the gap interface 111 between each pair of adjacent plates is sized to exclude a designed fraction of the distribution of particulate sizes from entering therein.

In the prior art, each plate of a stack of plates has been of a design resulting in coincident inner and outer edges, aligning along a line parallel to the axis or perpendicular to the plane of the planar plates. In other words, when the plates happen to be stacked axially and secured together for use, all the inner and outer edges align axially.

Applicant has noted that individual particulates 162 are often received and become lodged along the prior art aligned, and spaced, edges of the gap interface, the aligned edges of the plates imposing particulate-retaining or trapping forces. The retaining forces are not unlike wedge-type stops (like a door wedge) that functions largely because of the friction generated between the bottom of the door and the wedge, and the wedge and the floor (or other surface). Herein the analogue to the door stop's context of floor and door are formed by the opposing plate edges, the particulate acting as a wedge in the gap between the two opposing plate edges.

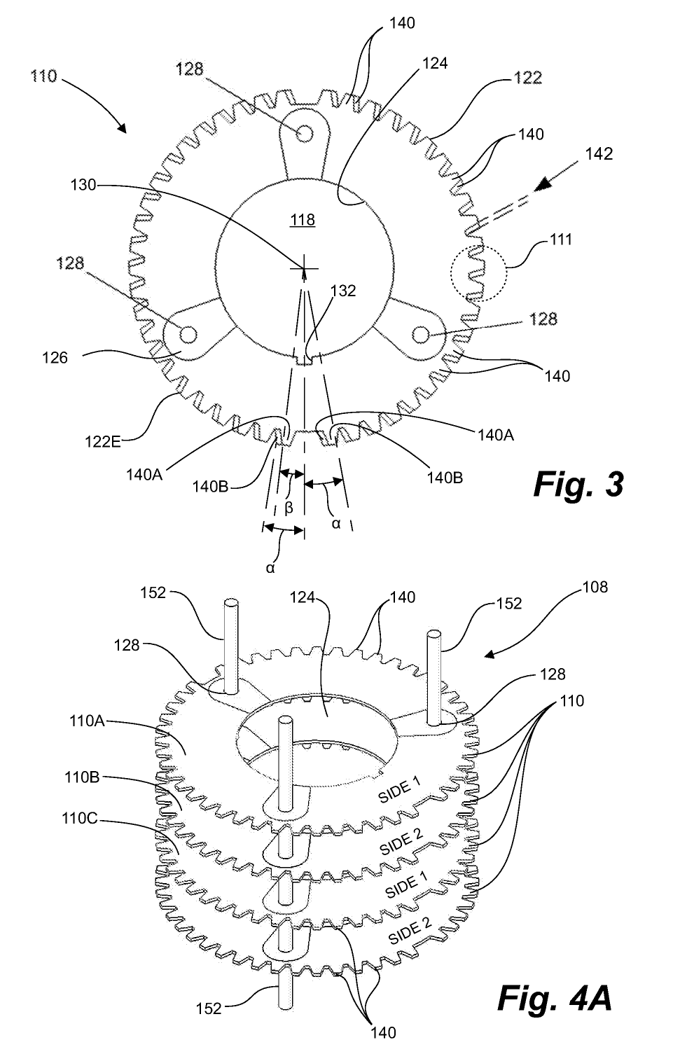

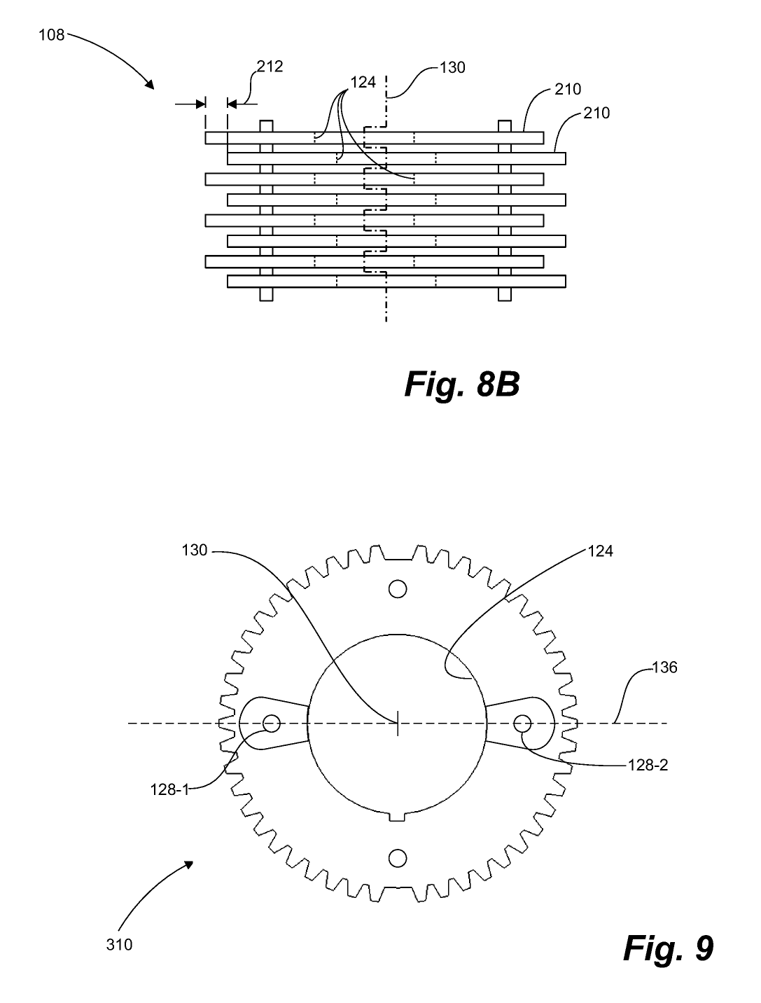

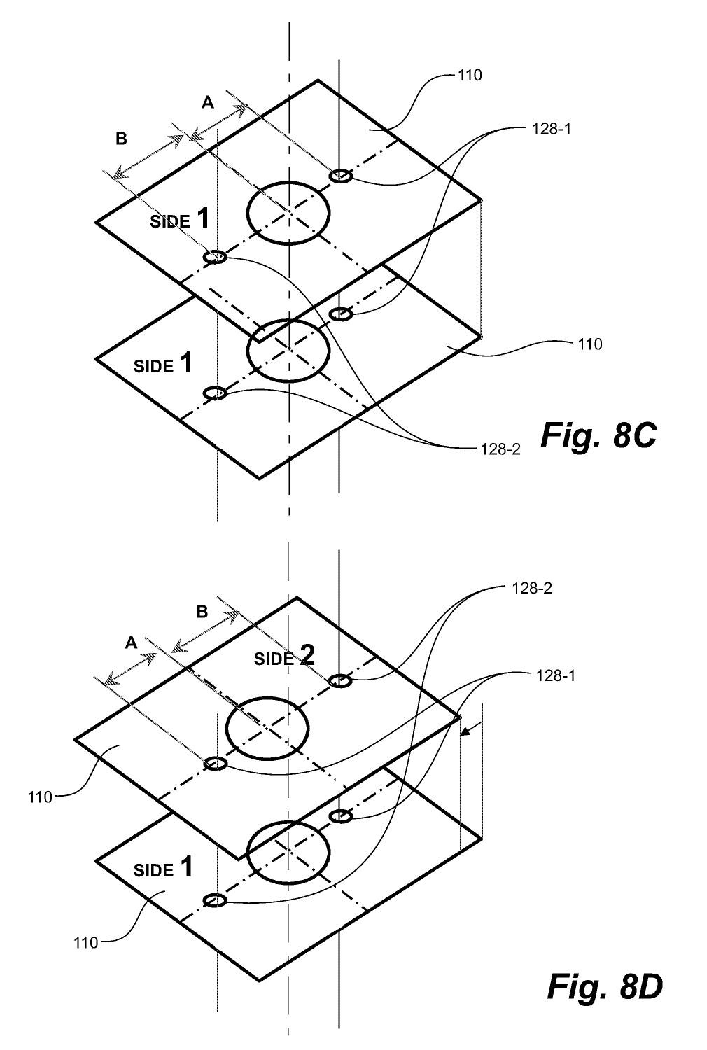

Herein, in embodiment, as shown in FIGS. 3 and 8A for example, Applicant discloses a filter 108 implementing plates 110 having a purposeful misalignment or offset 142 and 212 respectively, of the respective and adjacent outer edges 122,122, or inside edges 124,124, or both, to mitigate particulate retention and clogging at the filter gap interface 111. The inlet edge of one plate 110 is misaligned from the respective adjacent inlet edge of the adjacent plate 110, for forming the offset gap interface 111 therebetween

With reference to FIGS. 5A and 5B, arrangement or configuration of the adjacent plates 110,110, results in misalignment in a significant portion of the edge, such as outer edges 122. The inlet edge of each plate 110 can be a pleated edge, the pleated edge of each pair of adjacent plates 110,110 forming the fluid inlet.

For a pleated outer edge having a tooth profile, the portions of the outer edge 122 that overlap are the generally radially-extending portions, forming angular offsets 212 along at least radially-extending edges, and as shown in FIG. 5B, with an overhang offset 212 and an underhung offset arrangement. As shown in FIG. 5A, a slight misalignment of the edges at the gap interface 111 disables opposing frictional jamming forces that retain particulates 162. The amount of overlap is discussed below.

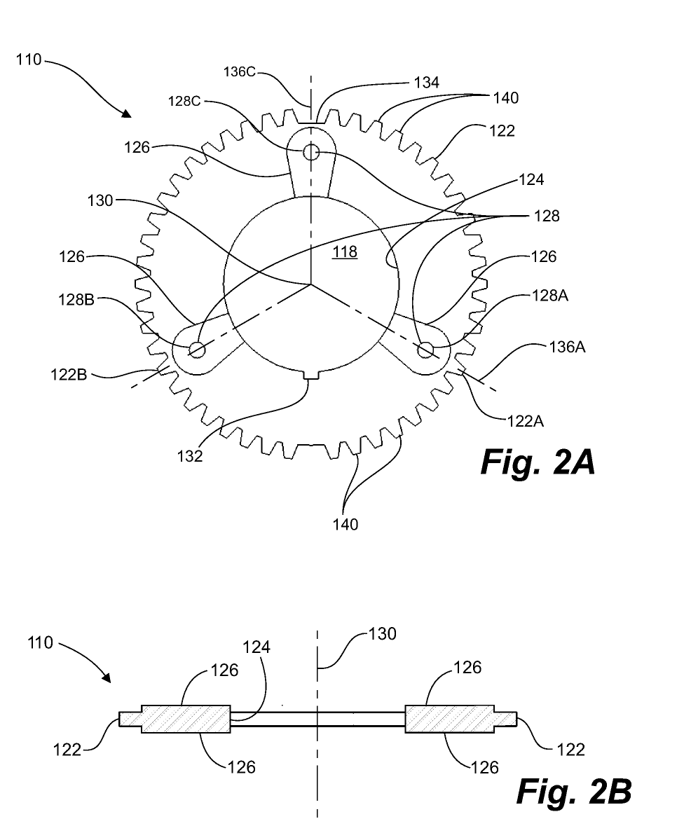

With reference to FIG. 2A, in another embodiment, at least some plates, and usually all active plates, of the plurality of plates, implement the pleated profile along the outer edge 122, inside edge 124, or both. A pleated profile includes scalloped, gear tooth-like and other like profiles along the plate's periphery. A radially undulating edge, having axially extending walls can have the form of a gear, such as a square rack tooth. In embodiments, at least the inlet periphery of the stacked plates is pleated to provide a large cross-sectional inlet area and, further, the periphery of adjacent plates can be offset to prevent clogging.

The pleated edges have several characteristics. One, the pleated profile forms an elongated length of periphery within a given plate enclosing diameter, undulating or variable radially along the circumference or periphery for increasing the surface area of each gap interface; the length of the edge multiplied by the gap spacing.

Each plate 110 has pleated edge for increasing the surface area of the gap interface 110 and the cross-sectional area of the gap opening therealong. In embodiments each plate 110 is a gear-like plate having a plurality of teeth 140,140 . . . about the outside edge 122 thereof.

As shown each plate 110 comprises a central opening 124 for receiving a fluid receiving pipe 105 having a fluid bore 107 and perforation therethrough for receiving fluid from the between the adjacent plates 110,110. The pipe 105 forms a fluid path for receiving clean fluid F_{OUT} at the pipe for continuing up the pipe bore for discharge at the fluid outlet 106. In this embodiment, the central opening 124 is keyed by having a notch or keyway 132 to provide alignment in addition to the general assembly and alignment provided by assembly rods 152 for coupling or passing through holes 128A, 128B and 128C for extra rigidity of the assembled stack.

A portion of the plate 110 in proximity with each assembly hole 128 has an increased thickness forming a raised-face area or upstanding boss 126 on at least one side, but which can also be on both sides of the plate 110, for providing required gap G between plates when assembled. Each plate has an upstanding boss 126 on at least one face of opposing first and second faces for spacing adjacent plates apart by a height of the boss. A boss-to-boss arrangement provides a gap G having a sum of the heights of the bosses.

While the assembly holes and rods aid in assembly, they may not provide the tolerance required for lip misalignment so as to enable particulate rejection. Particulate rejection can rely on more precise angular alignment of adjacent plates such as through the use of keyway 132 and a key on pipe 105. All plates can align with each other and pipe 105 through the keyed interface.

Further, while the plates 110,110 . . . can be of like dimensions, by providing alignment markers that are offset from a reference line or reference ray, yet aligned perpendicularly through the plate itself, plates can be misaligned simply by assembling adjacent plates one upright and the next plate upside down. The radially variable pleats are angularly offset from the reference ray in one direction a different amount that they are angularly offset from the reference ray in the opposing direction, wherein when the adjacent plate is flipped, the radially variable pleats are angularly offset for form the offset gap interface.

In the case of two adjacent and pleated plates, having the same inner and outer edge dimensions, can be misaligned angularly, having one pleat or tooth 140 offset angularly from the keyway, and when flipped upside down, that angular offset misaligns the radial profile of one tooth and the adjacent plate's tooth for providing the offset at the gap interface 111. The result of which is illustrated at FIG. 5B. For a repeating pleat profile, when referencing and angular offset for a pleat from the reference ray, the asymmetry of the angular offset is different than is the angular offset between adjacent pleats or multiples of the offsets.

The pleating or tooth-profile provides a pleated inlet edge of each plate forming generally radially-extending edges, and wherein the pleated edges of adjacent plates are angularly misaligned to form the offset gap interface at at least the radially-extending edges. The edges are only generally radially extending as the nature of some profiles, like a gear-tooth with a larger root than tip, is that the edges are alternating skewed either said of a radial.

Each plate 110,110A is angularly offset from the adjacent plate 110,110B by a small angle, reducing the embedment of particulates into the gap interface 111. Adjacent first faces of a pair of plates face each other and a pair of adjacent second faces face each other in the subsequent pair. Having the plates 110A,110B . . . assembled upon an axial supporting and angularly restraining structure such as pipe 105, results in alternating angular misalignment of the teeth.

As shown in FIG. 3, the teeth 140 aid in angular misalignment of the gap interface of adjacent plates 110,110. To achieve angular misalignment, the teeth 140,140 are angularly or rotationally offset, about the rotational axis 130, using from an alignment keyway 144 or other alignment yaw reference ray 136. A reference tooth 140A can be angularly skewed about ¼ of a particulate diameter or greater at the outer edge 122 so that upon a plate's reversal, the same tooth is angularly offset a complementary ¼ particulate size the other direction, resulting in tooth offset between adjacent plates of about ½ of the particulate diameter or greater. Alternate upright and upside down plate stacking results in slight misalignment or offset of the plate edges at the gap interface. Alternatively, the adjacent inlet edges of the first plate can be being angularly offset about ½° to about 1°, from the pleated inlet edges of the adjacent plate.

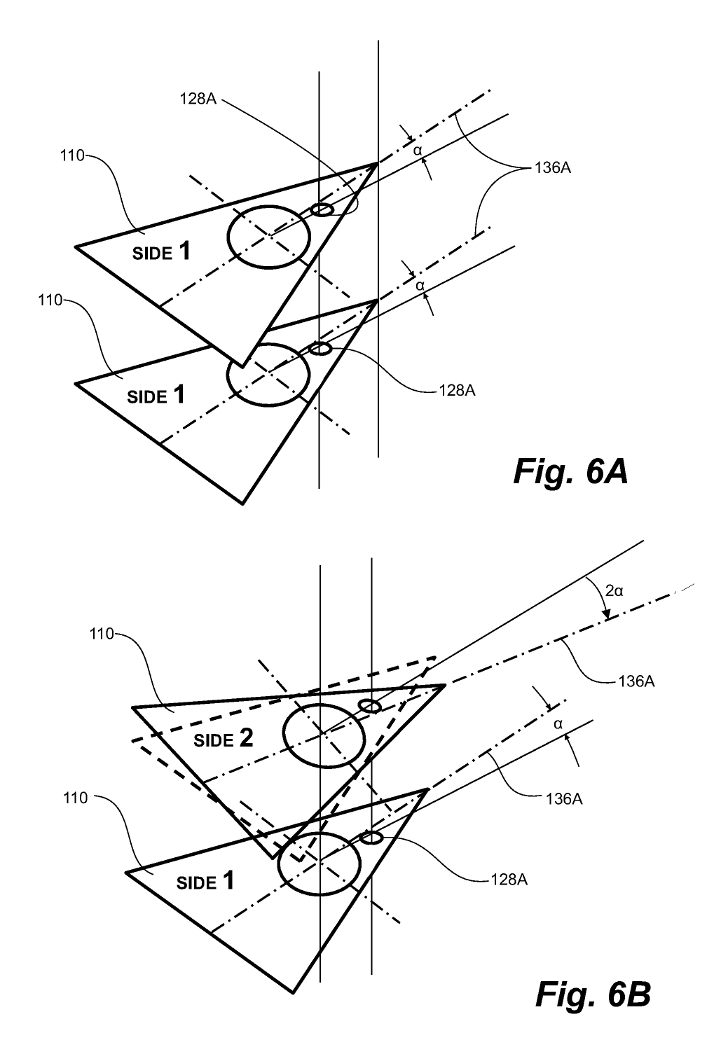

As shown in FIGS. 6A and 6B, in a simplified schematic form, in one method of using a reversible plate 110 to obtain angular misalignment, an alignment hole 128A is angularly offset α from a reference ray 136. As shown in FIG. 6A, when like plates, both oriented with side 1 upwardly, are aligned along the alignment hole, the points of the outer edge remain axially aligned. As shown in FIG. 6B, when the like plates, are oriented with one lower plate upside right (side 1 upwardly), and the upper plate oriented with upside down (side 1 downwardly and side 2 upwardly), the points of the respective outer edges rotate about the central axis of rotation and become are angularly offset by the sum of the angular offset α+α, or twice 2α as the angular misalignment.

Using mounting structure, such as pipe 105 with key 131, to retain the plates at a known angular position through keyway 132, plates can be assembled one upright and the next adjacent plate upside down, to cause misalignment by the sum of the offset. Accordingly, the teeth 140,140 and gap interface 111 of two adjacent plates, having the same inner and outer edge dimensions, will be misaligned. With the reversed plate arrangement, the upright and first face of a lower plate of a pair of plates faces the upside down, and first face, of the adjacent upper plate of a subsequent higher pair of plates. Thus, the upright and second face of lower of the subsequent pair of plates faces the upside down, and second face, of an upper and adjacent plate in yet another higher subsequent pair of plates and so on.

Accordingly, as shown in FIGS. 1, 3 and 4A, the stack of plates are fit to a central and generally cylindrical mandrel, such as the perforated pipe 105. The keyway 132, in each of the plates, aligns angularly with a key 131 on the pipe 105. The alignment rods 152, not relied upon for forming offset 212, can be provided with sufficient tolerance to avoid plate jamming during axial assembly. The keyway 132 and key 131 angularly arrange each plate 110 in the stack 108.

During assembly, a plurality of filter plates 110,110 . . . are stacked with their respective keyways 132 and key 131 aligned. The alignment also arranges and aligns the assembly holes 128A,B,C for receiving three corresponding assembly rods 152. The two-faced plates are arranged in an alternating manner of “facing-up” and “facing-down”. Herein, filter plates are alternatingly “facing-up” and “facing-down” in that the first or front faces of each pair of adjacent filter plates 110 are facing opposite directions such that, as shown in FIG. 4A, labelled as “side 1” and “side 2”, among any three adjacent filter plates 110A, 110B and 110C, the first faces (side 1) of the plates 110A and 110C face the same direction and the first face (side 1) of plate 110B in the middle thereof faces the opposite direction to that of the plates 110A and 110C.

In this embodiment, each tooth 140 of the plurality of teeth 140, of the pleated outer edge 122, is generally of the same size and circumferentially uniformly distributed. In the illustrated embodiment, each tooth 140 happens to be symmetrical about a radial reference ray drawn from the central rotational axis 130 thereof. As shown in FIG. 2A, in embodiments, the plate 110 may be absent one or more teeth about the periphery for ease of alignment and/or identification purposes.

The three assembly holes 128A, 128B and 128C are located on the plate 110 at a same distance from the rotational axis 130 of the plate 110, and at 120° to each other with respect to the rotational axis 130. Further, the assembly holes 128 are positioned such that, for each assembly hole 128, a tooth 140, or the tooth next to a notch 134, adjacent thereto, is asymmetrical with respect to the reference ray 136 between the rotational axis 130 and the center of the alignment hole 128. In this example, the reference rays are illustrates as passing through the alignment holes. Similarly, as shown in FIG. 3, a reference ray 136 can pass through the keyway 132.

The location of a reference ray is arbitrary except as it relates to the angular position of the teeth. For example, the tooth 140A adjacent and clockwise (CW) from keyway 132 is angularly asymmetrical or offset angle α from the reference ray passing through the keyway 132. The tooth 140B adjacent and counterclockwise (CCW) from keyway 132 is angularly asymmetrical or offset angle β from the reference ray. If the upper plate is flipped, by rotation about the reference ray, then the offset α of tooth 140B is then located on the opposing side of the reference ray, and misaligned from mirrored tooth 140A of the adjacent, identical and lower plate.

Such asymmetry of the teeth 122 results in different, offset angular patterns of the front and rear faces of the plate 110, in terms of the angular position relative to the assembly holes and reference ray. The asymmetry of the teeth 122 gives rise to angular offset between filter plates 110, after assembly, using identical plates when simply arranged in back-to-back, facing, flipped or opposing relation. Although grossly exaggerated, as can be seen, the teeth 122 of one plate are angularly offset, e.g., about 1°, from those of the other plate, resulting in offset edges of assembled filter plates 110.

As shown in FIG. 4A, during assembly, a plurality of filter plates 110 are stacked with the assembly holes 128 thereof aligned for receiving assembly rods 152, each plate 110 arranged in alternating fashion, one plate “facing-up” and the opposing plate “facing-down”. The plate's keyways 132 are aligned with the pipe's key 131.

In order to obtain angular separation; the plates' peripheries are pleated to form a plurality of generally radial edges, two radial edges per tooth. Each tooth and each radial edge is slightly offset from the reference ray and/or plate keyway. Thus adjacent plates having one tooth slightly offset CCW facing up and the tooth slightly offset CW for the adjacent plate facing down. The pleating profile of one plate, when flipped over, is shifted angularly from the adjacent pleat profile. Pleats both provide an increased surface area as well as a non-tangential, radial edges to allow for angular offset and misalignment.

As exaggerated in FIG. 5A, for providing a particulate-shedding interface, one selected magnitude of the misalignment is at least ½ of the particulate size or nominal diameter. Larger offsets, that an average particulate diameter, can also employed so as to covers a larger range of particulate diameters as well as to aid in the ease of manufacture. The gap is sized for some mean or average design particulate diameter and can vary depending on the particulate distribution.

With the assembly of the filter 108 comprising alternate flipping of a single plate, used for each of a stack of plates, only one mold is necessary, reducing costs and reducing errors in assembly. An alternate embodiment is to implement a mold for each offset through 360 degrees and thus avoid flipping plates. However, using an offset using ½ degrees, this method would require 720 molds, or even fraction thereof depending on the repeatability of the pleated profile. Another more practical alternate embodiment is to implement two molds, the alignment holes, of this dual plate embodiment, arranged to alternate ½ degree CW and ½ degree CCW each alternating plate in a zig-zag misalignment. The plates are then assembled into the filter stack 108, all facing upwards.

In erosive, hydrocarbon and high pressure environments, material choices can be expensive or challenging. Herein, the plates can be made of a synthetic material, which provides corrosion resistance and further provides for reduced fluid friction though the gap G and also for erosion resistance. One such synthetic material is a polymer material including silica and optionally further including nylon material. An injection mold process can be employed to inject the polymer material into a suitable mold for making the plates 110.

In some embodiments, the plates 110 are made of a polymer material having a strategic percentage of silica. For example, in one embodiment, the plates 110 are made of a polymer material, such as Nylene™ 5133 HS having about 33% silica, manufactured by Nylene Canada Inc. of Arnprior, Ontario, Canada. In another embodiment, the plates 110 are made of a polymer such as Vydene® R533 NT having about 33% silica, manufactured by Ascend Performance Materials of Houston, Tex., USA.

An inert polymer with a silica base is quite chemically neutral and can in the order of at least five times stronger in compression than stainless steel plate material, yet without issues related to H2S stress cracking in materials including austenitic stainless steels and oxidation problems associated with carbon steel. Depending on the particular material, some polymers are also recyclable when taken out of service.

Those skilled in the art appreciate that the plates 110 may alternatively be made of other suitable materials, for a suitable environment, including such less exotic materials such as carbon steel or stainless steel.

However, even when the environments are not severe, the polymer plates 110 also have advantages including reproducible manufacturing tolerances in the order of within 5/10,000ths of an inch (13 um). Such tolerances are more difficult to achieve economically in materials such as carbon or stainless steel. Further, such polymer plates can exhibit compressive strengths in the order of 10,000 psi (70000 kPa), contribute to lowering pressure drop across the plate due to reduced surface drag, and are also chemically resistant to oilfield chemicals.

Referring back to FIG. 1A, a fluid stream F_{IN} is injected from the inlet 104 into the housing 102. The fluid stream enters the gap G between each pair of filter plates 110,110. Any particulates in the fluid stream F_{IN} that are larger than the gap G are blocked by the gap at the inlet edge gap interface 111, and filtered out. The particulate-removed or clean fluid F_{OUT} then enters the perforated pipe 105, transported along the bore 107 for discharge at the fluid outlet 106.

Referring back to FIG. 5A, the offset edges of assembled filter plates 110 reduces the embedment of particulates in the gap between plates 110. Testing results show that particulates are mainly accumulated on the external surface of the plates 110. In use, pressure drop across the stacked-plate filter 108 is reduced.

The pressure in the vessel 102 can be in the order of 5,000 psi or greater. One can monitor the pressure differential between the inlet 104 and the outlet 106 to monitor for increasing pressure differential that affects upstream and downstream equipment. As particulates 162 adversely affect the filter performance or simply accumulate in the vessel 102 and obscure the filter, the pressure differential builds. The vessel 102 may need to be periodically back flushed and the vessel 102 can be purged of the filtered particulates F_{C}.

To back flush the filter 108, or even fluidize settled particulates in the vessel, the fluid inlet 104 or other shutoff upstream of the inlet 104 can be closed to block the process fluids of the feedstream F_{IN}. Depending on the downstream conditions, the fluid outlet 106 may also be temporarily closed. The particulate cleanout 109 can then be opened. The fluid outlet 106 can be re-opened, and cleanout or back flush fluid can then be pumped into the fluid outlet 106, backwards through the filter 108, to urge any errant particulates out of the gap G and off of the inlet edges of the filter 108. The back flush fluid and filtered particulates F_{C} are removed from the vessel through actuation of the cleanout 109. Further, if a packed bed of particulates collected in the bottom of the vessel 102, the back flush fluid can also act to fluidize the particulate bed, the resulting fluidized slurry of filtered particulates F_{C} being readily removed through the cleanout 109.

In some aspects, with unconsolidated particulates accumulated in the vessel 102, it may be possible to remove particulates without a back flush while operating normally under pressure, by a bleeding of process fluid and particulates, or in a more controlled process, periodically dumping process fluid and particulates through a double valve airlock to maintain vessel pressure while dumping filtered particulates F_{C} at ambient pressures.

Those skilled in the art appreciate that various alternative embodiments are readily available.

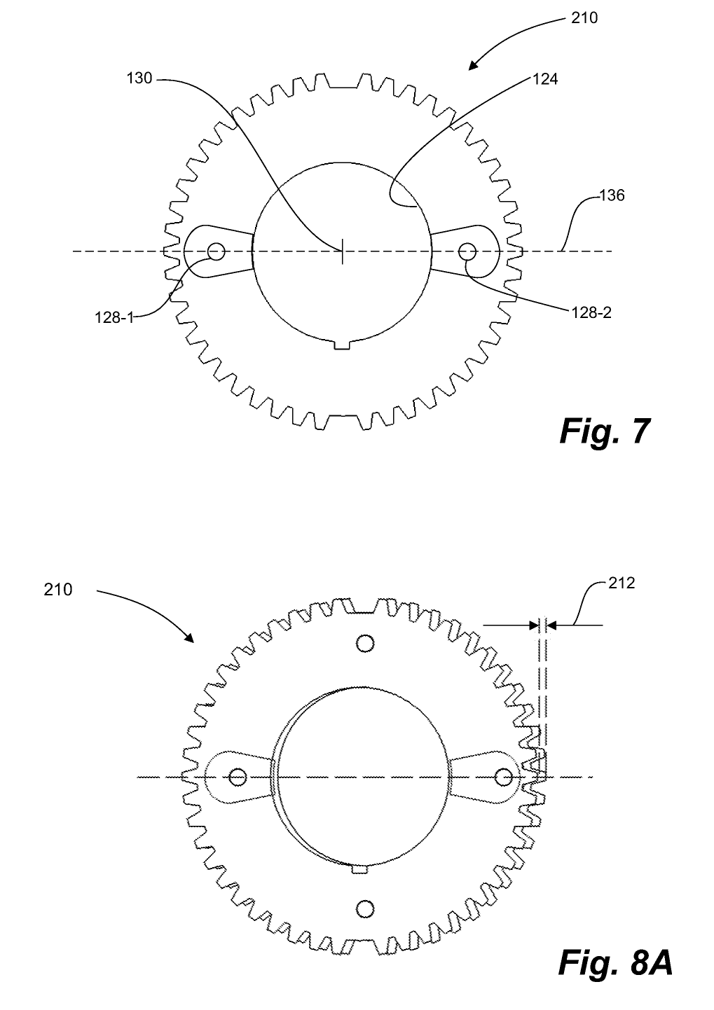

With reference to FIG. 7, and turning to a lateral offset arrangement the plate's central opening 124 is centered about the rotational axis 130. Two alignment holes, e.g., holes 128-1 and 128-2, are aligned along reference ray 136 through the rotational axis 130, but at different radial distances therefrom. For example, the distance between alignment hole 128-1 and the rotational axis 130 is larger than that between alignment hole 128-2 and the rotational axis 130.

As shown in FIGS. 8A, 8B and the schematic drawings of FIGS. 8C and 8D, a plurality of filter plates 210, of the lateral offset type, are stacked together in an alternating “facing-up” and “facing-down” arrangement, resulting in a lateral offset 212 between adjacent filter plates 210,210. As shown in FIG. 8B, and as a result, the central openings 124 and rotational axis 130 of the each of the stacked plates 210 are alternatingly misaligned.

With reference to FIG. 9, according to an alternative embodiment, a plate 310 has a similar central opening 124 and two alignment holes of FIG. 7. The alignment holes 128-1 and 128-2 are along the same alignment ray 136 with the rotational axis 130. In this case, the alignment holes 128-1 and 128-2 are at the same distance from the central opening 124. However, the entirely of the grouping of the central opening 124 and the two alignment holes 128-1 and 128-2 is linearly or laterally offset from the rotational axis 130. Accordingly, the central opening 124 will always align when the plates are arranged facing-up, or facing down.

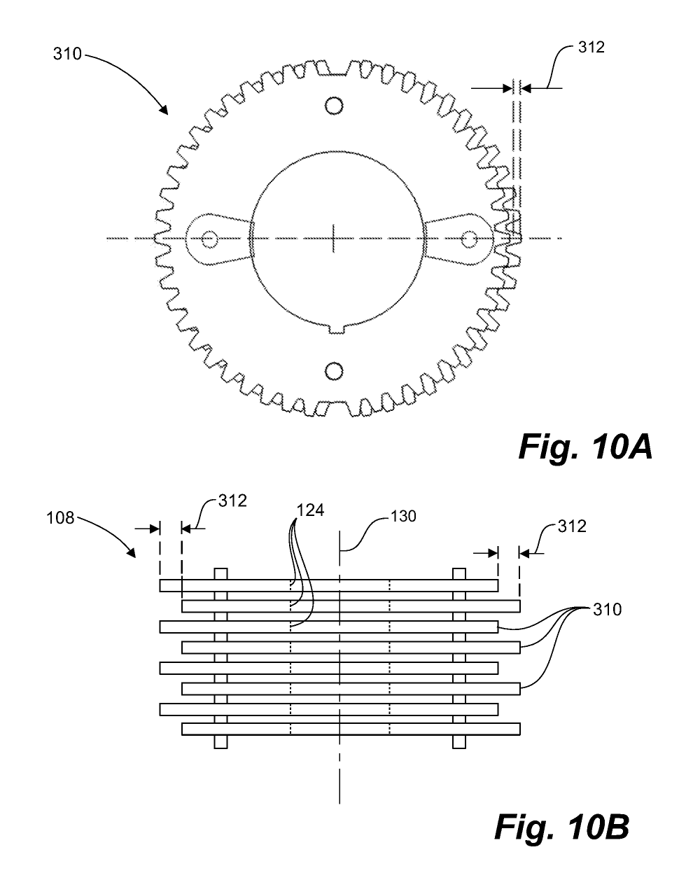

As shown in FIGS. 10A and 10B, a plurality of filter plate 310 are stacked together with alternating “facing-up” and “facing-down”, resulting in lateral offset 312 between adjacent filter plates 310. As shown in FIG. 10B, in this embodiment, the central openings 124 of the stacked plates 310 remain aligned.

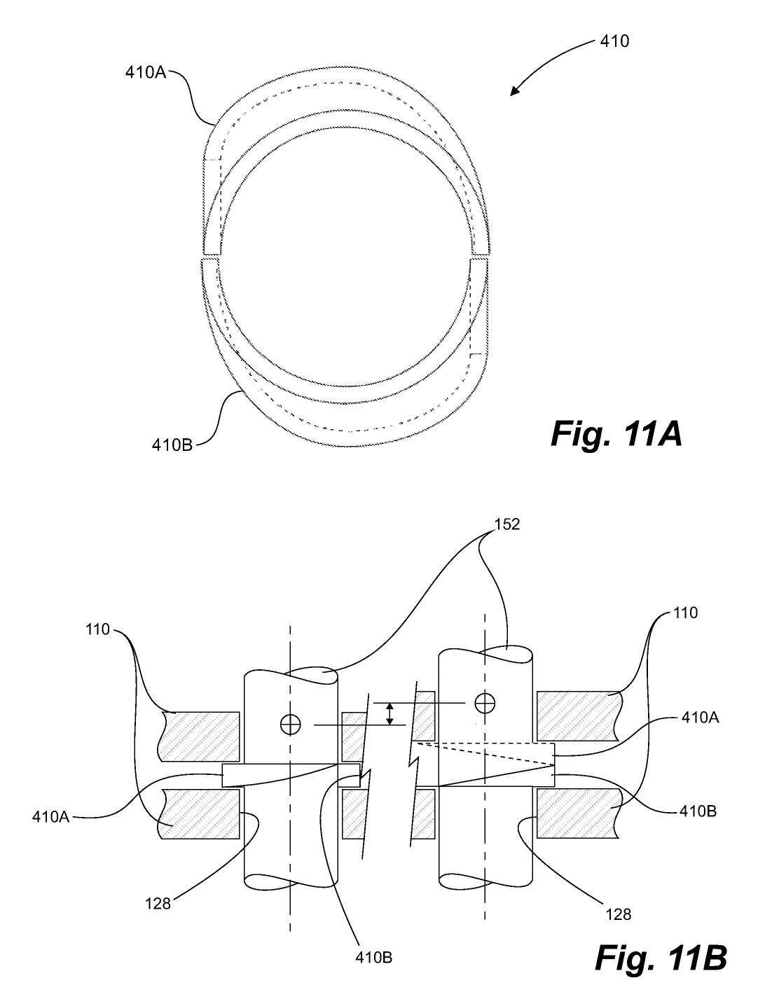

In an alternative embodiment, the gaps between plates 110, 210 or 310 as the plated design context would indicate, may be temporarily increased for back flushing. As shown in FIGS. 11A and 11B, a wedged split ring 410 is used as a spacer about an assembly rod between two plates 110. The split ring 410 may replace the bosses, or supplement the boss spacing. Having three assembly rods 152, three split rings 410 are used as spacers between two plates, one for each assembly rod 152. If the bosses 126 are used for precise sixing of gap G, the variable spacing split rings, when at rest, can have a thickness less than the boss-to-boss spacing. When actuated, the split ring thickness can overtake the boss spacing for the operation gap G and can further increase the spacing for particulate release and cleaning.

Each split ring comprises two pieces 410A and 410B, each having peripherally uneven thickness. One piece 410A or 410B is coupled to the rod, and the other piece is attached to the plate 110 approximate the alignment hole 128 thereof for receiving the rod. Rotating a rod rotates the ring piece attached thereto to overlap with the other piece attached to the plate 110, and increases the spacing between two plates 110 from the operational gap G to a maintenance gap GM. Therefore, one may rotate the three rods to increase the maintenance gap GM, between each pair of plates 110, for back flushing to remove embedded particulates. For example, during back flushing, the maintenance gap GM between each pair of plates 110 may be increased to two (2) times of the gap G provided during normal use.

In an alternative embodiment, the stacked-plate filter 108 does not have any assembly rods. In this embodiment, as introduced above, the perforated pipe 105 can be a rigid pipe with a key 131 matching the keyway 132 of each plate 110 for providing required alignment.

In another embodiment, such as a stack 108 having assembly rods, a perforated pipe 105 is not used. The rods compress the stack 108. Instead of the pipe 105, the inside edges 124 of the central openings 118 of the stacked plates 110 terminate at the central bore 107 to form the fluid path coupled to the fluid outlet 106 for discharging clean fluid F_{OUT}.

In an alternative embodiment, some or all of the bosses 126 may be distributed about the plate 110 at locations other than alignment holes 128.

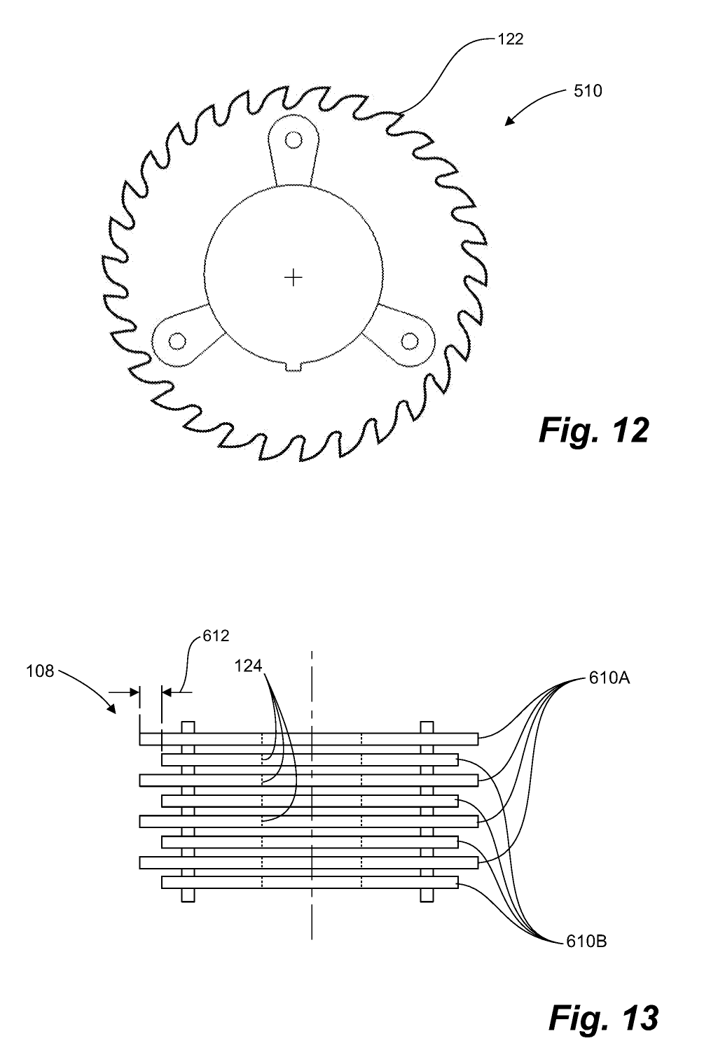

In an alternative embodiment as shown in FIG. 12, each tooth 122 of each filter plate 510, like a saw tooth for example, can be asymmetric for forming generally backswept and forward swept radial edges for the forming angular offset when assembled.

In some embodiments, different or alternating plates may have different shapes and/or sizes or configurations generally for forming edge offsets. The inlet edge for each of the first and the second plates at the fluid inlet differing in configuration for forming the offset gap interface. For example, FIG. 13 shows a stacked-plate filter 108 having a first set of plates 610A of a first, larger size, alternating with a second set of plates 610B of a second, smaller size. In this case, one duplicates a plurality of first plates and a plurality of second plates, each first plate having inlet edges offset from the inlet edges of second plates. When stacked, each first plate is adjacent a second plate for forming the offset gap interface.

In some embodiments, the inner or outer edges of the stacked plates are pleated, but aligned, such as one plate design being used throughout the filter stack, and thus does not exhibit any offset. For example, in one of these embodiments, the plates have a circular shape with a same size. In other embodiments, again with reference to FIG. 13, the stacked plates could have uniform outside or inside edges, lacking pleats or other surface area enhancing profiles, and thus any offset is strictly radial.

What is claimed is:

1. A stacked-plate filter comprising:
a plurality of plates stacked along an axis and adjacent one another, each plate comprising a central opening forming an inner edge about the axis and an outer periphery forming an outer edge;
each pair of adjacent plates being parallel to one another and spaced apart to form a gap therebetween for flow of fluid therethrough from adjacent inlet edges formed at one of either the adjacent inner or outer edges; and
wherein the inlet edge of one plate is misaligned from the respective adjacent inlet edge of the adjacent plate, for forming an offset gap interface therebetween.

2. The filter of claim 1, wherein the inlet edge of each plate is a pleated edge, the pleated edge of each pair of adjacent plates forming the fluid inlet.

3. The filter of claim 1, wherein the inlet edge is the outer edge of each plate, the outer edge having a pleated profile and adjacent outer edges forming the inlet edges of the fluid inlet.

4. The filter of claim 1, wherein the outer edge of each plate is a pleated edge forming a plurality of radially-extending edges, and wherein the pleated edges of adjacent plates are angularly misaligned to form the offset gap interface at at least the radially-extending edges.

5. The filter of claim 1, wherein the offset gap interface is misaligned by a lateral misalignment.

6. The filter of claim 1, wherein the offset gap interface is misaligned at least ½ of the diameter of particulates being filtered.

7. The filter of claim 1, wherein each pair of plates comprise first and second plates, the inlet edge for each of the first and the second plates at the fluid inlet differing in configuration for forming the offset gap interface.

8. The filter of claim 1, wherein the inlet edge for each plate has the same configuration as the inlet edge configuration of the adjacent plate, each plate having a first face and a second face, and when adjacent plates are arranged with a first face of one plate facing the first face of the adjacent plate, the respective inlet edges are misaligned for forming the offset gap interface.

9. The filter of claim 1, wherein each plate's inlet edge a pleated edge forming a plurality of radially-extending edges, and wherein the radially-extending edges of one plate are angularly spaced in one direction from a reference ray at a different spacing than the radially-extending edges angularly spaced in the other one direction from a reference ray of one plate, wherein when adjacent plates are aligned along the reference ray, the radially-extending edges form the offset gap interface.

10. The filter of claim 1, wherein each plate comprises two or more alignment holes therethrough, the adjacent inlet edges being aligned when adjacent plates are stacked with the first face of one plate facing the second face of the adjacent plate with the two or more alignment holes are aligned with each other; and the adjacent inlet edges being misaligned when adjacent plates are stacked with the first face of one plate facing the first face of the adjacent plate with two or more alignment holes are aligned with each other.

11. The filter of claim 1, wherein the plurality of plates are supported on a perforated pipe forming a fluid bore therealong and having a key extending axially along the exterior thereof, each gap in fluid communication with the fluid bore, and each plate having a keyway for alignment with the key for misaligning adjacent plates.

12. The filter of claim 10, wherein the adjacent inlet edges are pleated, the adjacent inlet edges of the first plate being angularly offset about ½° to about 1°, from the pleated inlet edges of the adjacent plate.

13. The filter of claim 1, wherein the inlet edge has a toothed profile.

14. The filter of claim 1 wherein each plate has an upstanding boss on at least one face of opposing first and second faces for spacing adjacent plates apart by a height of the boss.

15. The filter of claim 1, wherein the filter receives a feedstream of fluid containing particulates, and the offset gap interface of the fluid inlet is misaligned at least ½ of the diameter of the particulates in the feedstream.

16. A filter assembly comprising:
a vessel,
a fluid inlet for injecting the fluid stream into the vessel;
a fluid outlet for discharging cleaned fluid from the vessel; and
a stacked-plate filter according to claim 1.

17. A filter assembly comprising:
a vessel;
a fluid inlet for injecting the fluid stream into the vessel;
a fluid outlet for discharging cleaned fluid from the vessel; and
a stacked-plate filter housed within the vessel forming an annulus therebetween, the filter comprising a plurality of plates, each plate having an opening therethrough for forming an inner edge and an outer periphery forming an outer edge, the opening forming a fluid bore, one of the fluid bore or annulus connected to the fluid inlet and the other of the annulus or fluid bore connected to the fluid outlet, each pair of adjacent plates being parallel to one another and spaced apart to form a gap therebetween for fluid flow from the fluid inlet and between inlet edges at one of either the adjacent inner or outer edges to discharge from the other of the outer or inner edges to the fluid outlet, the inlet edge of one plate being misaligned from the respective adjacent inlet edge of the adjacent plate, for forming an offset gap interface therebetween.

18. A method of assembling a stacked-plate filter assembly comprising:
providing a plurality of like plates of revolution, each plate having an axis, a central opening about the axis forming inner edges, and a periphery forming outer edges, one of the inner or outer edge forming an fluid inlet edge; and
stacking each plate axially adjacent another plate with the fluid inlet edges misaligned for forming an offset gap interface.

19. The method of claim 17, further comprising duplicating a plurality of plates by forming a radially variable pleats about the inlet edges, the angular location of each pleat having a reference location offset from a reference ray, the angular offset being different than the spacing between pleats; and wherein each plate has a first face and a second face, stacking each plate comprising stacking one plate with its first face facing the first face of a flipped and adjacent plate.

20. The method of claim 18, wherein the radially variable pleats are angularly offset from the reference ray in one direction a different amount that they are angularly offset from the reference ray in the opposing direction, wherein when the adjacent plate is flipped, the radially variable pleats are angularly offset for form the offset gap interface.

21. The method of claim 17, further comprising duplicating a plurality of first plates and a plurality of second plates, each first plate having inlet edges offset from the inlet edges of second plates; and stacking each plate comprises stacking a first plate adjacent a second plate.
